(19) United States
(12) Patent Application Publication
(10) Pub. No.: US 2026/0159659 A1
(43) Pub. Date: Jun. 11, 2026

(54) POLYURETHANE FOAM AND METHODS OF FORMING THE SAME

(71) Applicant: SAINT-GOBAIN PERFORMANCE PLASTICS CORPORATION, Malvern, PA (US)

(72) Inventors: Luqing Chen, Shanghai (CN); Yan Zhou, Shanghai (CN); Wenjun Sun, Shanghai (CN)

(21) Appl. No.: 19/410,078

(22) Filed: Dec. 5, 2025

Related U.S. Application Data
(60) Provisional application No. 63/738,014, filed on Dec. 23, 2024.

(30) Foreign Application Priority Data
Dec. 10, 2024 (CN) 202411813038.0

(51) Int. Cl. C08J 9/00; C08G 18/08; C08G 18/42; C08G 18/48; C08G 101/00

(52) U.S. Cl. CPC C08J 9/0014; C08G 18/14; C08G 18/4277; C08G 18/4829; C08G 2101/00; C08G 2110/0058; C08G 2110/0066; C08J 2375/08

(57) ABSTRACT

A polyurethane foam may include a first polyol component, a second polyol component, and an isocyanate component. The first polyol component may include a polyether polyol component. The second polyol component may include a polycaprolactone polyol component. The polyurethane foam may have at least two glass transition (Tg) peaks.

### CROSS-REFERENCE TO RELATED APPLICATION(S)

This application claims priority to Chinese Patent Application No. 202411813038.0, filed Dec. 10, 2024, entitled “POLYURETHANE FOAM AND METHODS OF FORMING THE SAME,” by Luqing CHEN et al., which is assigned to the current assignee hereof and incorporated herein by reference in its entirety. This application further claims priority under 35 U.S.C. § 119(e) to U.S. Provisional Patent Application No. 63/738,014, filed Dec. 23, 2024, entitled “POLYURETHANE FOAM AND METHODS OF FORMING THE SAME,” by Luqing CHEN et al., which is assigned to the current assignee hereof and incorporated herein by reference in its entirety.

### FIELD OF THE DISCLOSURE

The present disclosure relates to a polyurethane foam and methods of forming the same, more particularly, the present disclosure related to a polyurethane foam having improved performance and methods of forming the same.

### BACKGROUND

Polyurethane foams are widely used in applications of construction, transportation, and electronics. However, such polyurethanes foams often include specific characteristics that make them prone specific safety issues. For example, such polyurethane foams are generally prone to rapid fire growth due to their inherent chemical properties (i.e., the “—NH—COO— groups” of the polyurethane foam cause lower decomposition temperature than many other polymers) and physical properties (i.e., low density of the polyurethane causes severe dripping during combustion and porous structure promotes oxygen and heat transfer). Accordingly, polyurethane foam formulations with improved safety characteristics are desired.

### SUMMARY

According to a first aspect, a polyurethane foam may include a first polyol component, a second polyol component, and an isocyanate component. The first polyol component may include a polyether polyol component. The second polyol component may include a polycaprolactone polyol component. The polyurethane foam may have at least two glass transition (Tg) peaks.

According to yet another aspect, a polyurethane foam may include a reaction product of a raw mixture, where the raw mixture may include a raw first polyol component, a raw second polyol component, and a raw isocyanate component. The raw first polyol component may include a polyether polyol component. The raw second polyol component may include a polycaprolactone polyol component. The polyurethane foam may have at least two glass transition (Tg) peaks.

According to yet another aspect, a method of forming a polyurethane foam may include providing a raw material mixture and forming the raw material mixture into a polyurethane foam. The raw material mixture may include a raw first polyol component, a raw second polyol component, and a raw isocyanate component. The raw first polyol component may include a polyether polyol component. The raw second polyol component may include a polycaprolactone polyol component. The polyurethane foam may have at least two glass transition (Tg) peaks.

### BRIEF DESCRIPTION OF THE DRAWINGS

Embodiments are illustrated by way of example and are not limited to the accompanying FIGURES.

FIG. 1 includes a diagram showing a polyurethane foam forming method 100 according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a polyurethane foam and methods of forming the same. More particularly, embodiments described herein are directed to a polyurethane foam having improved resilience performance through the presence of at least two glass transition (Tg) peaks, and methods of forming the same.

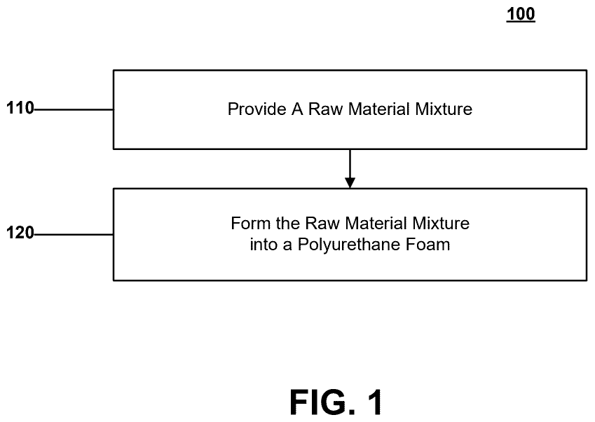

For purposes of illustration, FIG. 1 includes a diagram showing a polyurethane foam forming method 100 according to particular embodiments described herein. The polyurethane forming method 100 may include a first step 110 of providing a raw material mixture and a second step 120 of forming the raw material mixture into a polyurethane foam.

Referring to the first step 110, according to certain embodiments, the raw material mixture may include a raw first polyol component, a raw second polyol component, and a raw isocyanate component.

According to certain embodiments, the raw material mixture may include a particular content of raw first polyol component. For example, the raw material mixture may include a content of the raw first polyol component of at least about 30 wt. % for a total weight of the raw material mixture, such as, at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or even at least about 44 wt. %. According to yet other embodiments, the raw material mixture may include a content of the raw first polyol component of not greater than about 60 wt. % for a total weight of the raw material mixture, such as, not greater than about 58 wt. % or not greater than about 55 wt. % or not greater than about 53 wt. % or not greater than about 50 wt. % or not greater than about 48 wt. % or even not greater than about 46 wt. %. It will be appreciated that the content of the raw first polyol component in the raw material mixture may be within a range between any of the minimum and maximum values noted above. It will be further appreciated that the content of the raw first polyol component in the raw material mixture may be any value between any of the minimum and maximum values noted above.

According to yet other embodiments, the raw first polyol component may have a particular hydroxyl value. For example, the raw first polyol component may have a hydroxyl value of at least about 18 mgKOH·g⁻¹, such as, at least about 19 mgKOH·g⁻¹ or at least about 21 mgKOH·g⁻¹ or at least about 23 mgKOH·g⁻¹ or at least about 25 mgKOH·g⁻¹ or at least about 37 mgKOH·g⁻¹ or at least about 30 mgKOH·g⁻¹ or at least about 33 mgKOH·g⁻¹ or even at least about 35 mgKOH·g⁻¹ or even at least about 37 mgKOH·g⁻¹ or even at least about 39 mgKOH·g⁻¹. According to still other embodiments, the raw first polyol component may have a hydroxyl value of not greater than about 60 mgKOH·g⁻¹, such as, not greater than about 57 mgKOH·g⁻¹ or not greater than about 55 mgKOH·g⁻¹ or not greater than about 53 mgKOH·g⁻¹ or not greater than about 50 mgKOH·g⁻¹ or not greater than about 47 KOH mgKOH·g⁻¹ or not greater than about 45 mgKOH·g⁻¹ or even not greater than about 43 mgKOH·g⁻¹. It will be appreciated that the hydroxyl value of the raw first polyol component may be within a range between any of the minimum and maximum values noted above. It will be further appreciated that the hydroxyl value of the raw first polyol component may be any value between any of the minimum and maximum values noted above.

According to still other embodiments, the raw first polyol component may include polyether polyol components. According to still other embodiments, the raw first polyol component may be a propylene oxide (PO) end capped polyol component. According to yet other embodiments, the raw first polyol component may contain substantially no ethylene oxide (EO).

According to yet other embodiments, the raw first polyol component may have a particular functionality. For example, the raw first polyol component may have a functionality of at least 2, such as, at least 2.5 or at least 3 or at least 3.5 or at least 4 or even at least 5. According to still other embodiments, the raw first polyol component may have a functionality of not greater than about 6, such as, not greater than about 5 or not greater than about 4 or not greater than about 3 or even not greater than about 2. It will be appreciated that the functionality of the raw first polyol component may be within a range between any of the minimum and maximum values noted above. It will be further appreciated that the functionality of the raw first polyol component may be any value between any of the minimum and maximum values noted above.

According to other embodiments, the raw first polyol component may have a particular molecular mass. For example, the raw first polyol component may have a molecular mass of at least about 2000 g/mol, such as, at least about 2200 g/mol or at least about 2400 g/mol or at least about 2600 g/mol or at least about 2700 g/mol or at least about 2800 g/mol or at least about 2900 g/mol or even at least about 3000 g/mol. According to still other embodiments, the raw first polyol component may have a molecular mass of not greater than about 8000 g/mol, such as, not greater than about 7000 g/mol or not greater than about 6000 g/mol or not greater than about 5000 g/mol or not greater than about 4500 g/mol or not greater than about 4000 g/mol or not greater than about 3900 g/mol or not greater than about 3800 g/mol or not greater than about 3700 g/mol or not greater than about 3600 g/mol or not greater than about 3500 g/mol or not greater than about 3400 g/mol or not greater than about 3300 g/mol or not greater than about 3200 g/mol or even not greater than about 3100 g/mol. It will be appreciated that the molecular mass of the raw first polyol component may be within a range between any of the minimum and maximum values noted above. It will be further appreciated that the molecular mass of the raw first polyol component may be any value between any of the minimum and maximum values noted above.

According to yet other embodiments, the raw first polyol component may have a particular solid content by weight. For example, the raw first polyol component may have a solid content by weight of at least about 1.0 wt. %, such as, at least about 3.0 wt. % or at least about 5.0 wt. % or at least about 10.0 wt. % or at least about 15.0 wt. % or at least about 20.0 wt. % or at least about 25.0 wt. % or at least about 30.0 wt. % or at least about 35.0 wt. % or at least about 40.0 wt. % or at least about 43.5 wt. % or at least about 44.0 wt. % or at least about 44.5 wt. % or even at least about 45.0 wt. %. According to still other embodiments, the raw first polyol component may have a solid content by weight of not greater than about 50.0 wt. %, such as, not greater than about 49.5 wt. % or not greater than about 49.0 wt. % or not greater than about 48.5 wt. % or not greater than about 48.0 wt. % or not greater than about 47.5 wt. %. It will be appreciated that the solid content by weight of the raw first polyol component may be within a range between any of the minimum and maximum values noted above. It will be further appreciated that the solid content by weight of the raw first polyol component may be any value between any of the minimum and maximum values noted above.

According to particular embodiments, suitable solid organic fillers making up the solid content of the raw first polyol may include styrene/acrylonitrile (SAN) particles prepared by free radical polymerization of monomers (i.e., styrene and acrylonitrile), PHD polyurea (formed in situ by polymerization of a diamine and an isocyanate), or PIPA (polyisocyanate polyaddition formed by reaction of an alkanolamine with an isocyanate). According to other embodiments, suitable solid organic fillers making up the solid content of the raw first polyol may consist essentially of styrene/acrylonitrile (SAN) particles prepared by free radical polymerization of monomers (i.e., styrene and acrylonitrile), PHD polyurea (formed in situ by polymerization of a diamine and an isocyanate), or PIPA (polyisocyanate polyaddition formed by reaction of an alkanolamine with an isocyanate).

According to certain embodiments, the raw material mixture may include a particular content of raw second polyol component. For example, the raw material mixture may include a content of the raw second polyol component of at least about 3 wt. % for a total weight of the raw material mixture, such as, at least about 4 wt. % or at least about 5 wt. % or at least about 6 wt. % or at least about 7 wt. % or at least about 8 wt. % or at least about 9 wt. % or at least about 10 wt. % or at least about 11 wt. % or even at least about 12 wt. %. According to yet other embodiments, the raw material mixture may include a content of the raw second polyol component of not greater than about 25 wt. % for a total weight of the raw material mixture, such as, not greater than about 24 wt. % or not greater than about 23 wt. % or not greater than about 22 wt. % or even not greater than about 21 wt. % or even not greater than about 20 wt. % or even not greater than about 19 wt. % or even not greater than about 18 wt. % or even not greater than about 17 wt. % or even not greater than about 16 wt. % or even not greater than about 15 wt. %. It will be appreciated that the content of the raw second polyol component in the raw material mixture may be within a range between any of the minimum and maximum values noted above. It will be further appreciated that the content of the raw second polyol component in the raw material mixture may be any value between any of the minimum and maximum values noted above.

According to yet other embodiments, the raw second polyol component may have a particular hydroxyl value. For example, the raw second polyol component may have a hydroxyl value of at least about 150 mgKOH·g⁻¹, such as, at least about 170 mgKOH·g⁻¹ or at least about 190 mgKOH·g⁻¹ or at least about 200 mgKOH·g⁻¹ or at least about 205 mgKOH·g⁻¹ or at least about 210 mgKOH·g⁻¹ or at least about 215 mgKOH·g⁻¹ or at least about 220 mgKOH·g⁻¹ or even at least about 225 mgKOH·g⁻¹. According to still other embodiments, the raw second polyol component may have a hydroxyl value of not greater than about 300 mgKOH·g⁻¹, such as, not greater than about 280 mgKOH·g⁻¹ or not greater than about 260 mgKOH·g⁻¹ or not greater than about 250 mgKOH·g⁻¹ or not greater than about 245 mgKOH·g⁻¹ or not greater than about 240 mgKOH·g⁻¹ or not greater than about 235 mgKOH·g⁻¹ or not greater than about 230 mgKOH·g⁻¹ or even not greater than about 228 mgKOH·g⁻¹. It will be appreciated that the hydroxyl value of the raw second polyol component may be within a range between any of the minimum and maximum values noted above. It will be further appreciated that the hydroxyl value of the raw second polyol component may be any value between any of the minimum and maximum values noted above.

According to still other embodiments, the raw second polyol component may have a particular functionality. For example, the raw second polyol component may have a functionality of at least about 1, such as, at least about 2 or even at least about 3. According to still other embodiments, the raw second polyol component may have a functionality of not greater than about 6, such as, not greater than about 5 or even not greater than about 4. It will be appreciated that the functionality of the raw second polyol component may be within a range between any of the minimum and maximum values noted above. It will be further appreciated that the functionality of the raw second polyol component may be any value between any of the minimum and maximum values noted above.

According to other embodiments, the raw second polyol component may have a particular molecular mass. For example, the raw second polyol component may have a molecular mass of at least about 400 g/mol, such as, at least about 410 g/mol or at least about 420 g/mol or at least about 430 g/mol or at least about 440 g/mol or at least about 450 g/mol or at least about 460 g/mol or even at least about 470 g/mol. According to still other embodiments, the raw second polyol component may have a molecular mass of not greater than about 1200 g/mol, such as, not greater than about 1150 g/mol or not greater than about 1100 g/mol or not greater than about 1000 g/mol or not greater than about 950 g/mol or not greater than about 900 g/mol or not greater than about 850 g/mol or not greater than about 800 g/mol or not greater than about 750 g/mol or even not greater than about 700 g/mol or even not greater than about 650 g/mol or even not greater than about 600 g/mol. It will be appreciated that the molecular mass of the raw second polyol component may be within a range between any of the minimum and maximum values noted above. It will be further appreciated that the molecular mass of the raw second polyol component may be any value between any of the minimum and maximum values noted above.

According to certain embodiments, the raw material mixture may include a particular content of the raw isocyanate component. For example, the raw material mixture may include a content of the raw isocyanate component of at least about 22.0 wt. % for a total weight of the raw material mixture, such as, at least about 23 wt. % or at least about 24 wt. % or at least about 25 wt. % or at least about 26 wt. % or at least about 27 wt. % or at least about 28 wt. % or at least about 29 wt. % or even at least about 30 wt. %. According to yet other embodiments, the raw material mixture may include a content of the raw isocyanate component of not greater than about 50 wt. % for a total weight of the raw material mixture, such as, not greater than about 49 wt. % or not greater than about 48 wt. % or not greater than about 47 wt. % or not greater than about 46 wt. % or not greater than about 45 wt. % or not greater than about 44 wt. % or not greater than about 43 wt. % or not greater than about 42 wt. % or not greater than about 41 wt. % or even not greater than about 40 wt. %. It will be appreciated that the content of the raw isocyanate component in the raw material mixture may be within a range between any of the minimum and maximum values noted above. It will be further appreciated that the content of the raw isocyanate component in the raw material mixture may be any value between any of the minimum and maximum values noted above.

According to still other embodiments, the raw isocyanate component may include 2,4-toluene diisocyanate (2,4-TDI), 2,6-toluene diisocyanate (2,6-TDI), hexamethylenediisocyanate (HDI), isophorone-diisocyanate (IPDI), 4,4′-Diphenylmethane diisocyanate (4,4′-MDI), 2,4′-Diphenylmethane diisocyanate (2,4′-MDI), Polymeric MDI (PMDI), 4,4′-Dicyclohexylmethane diisocyanate (HMDI). Other various isocyanate forms derivatives may be used such as uretidinedione or uretonimine-linked isocyanates.

According to still other embodiments, the raw isocyanate component may have a particular functionality. For example, the raw isocyanate component may have a functionality of at least about 2, such as, at least about 3. According to still other embodiments, the raw isocyanate component may have a functionality of not greater than about 6, such as, not greater than about 5 or even not greater than about 4. It will be appreciated that the functionality of the raw isocyanate component may be within a range between any of the minimum and maximum values noted above. It will be further appreciated that the functionality of the raw isocyanate component may be any value between any of the minimum and maximum values noted above.

According to still other embodiments, the raw material mixture may further include a raw first extender component.

According to still other embodiments, the raw first extender component may include compounds with at least two isocyanate reactive groups such as 1,4-butylene glycol, diethylene glycol, diethanolamine, ethylene diamine, triethylene glycol, dipropylene glycol, or tri propylene glycol.

According to certain embodiments, the raw material mixture may include a particular content of raw first extender component. For example, the raw material mixture may include a content of the raw first extender component of at least about 0.1 wt. % for a total weight of the raw material mixture, such as, at least about 0.3 wt. % or at least about 0.5 wt. % or at least about 0.75 wt. % or at least about 1.0 wt. % or at least about 1.25 wt. % or at least about 1.5 wt. % or at least about 1.75 wt. % or even at least about 2 wt. %. According to yet other embodiments, the raw material mixture may include a content of the raw first extender component of not greater than about 6.0 wt. % for a total weight of the raw material mixture, such as, not greater than about 5.5 wt. % or not greater than about 5.0 wt. % or not greater than about 4.5 wt. % or not greater than about 4.0 wt. % or not greater than about 3.5 wt. % or not greater than about 3 wt. % or even not greater than about 2.5 wt. %. It will be appreciated that the content of the raw first extender component in the raw material mixture may be within a range between any of the minimum and maximum values noted above. It will be further appreciated that the content of the raw first extender component in the raw material mixture may be any value between any of the minimum and maximum values noted above.

According to still other embodiments, the raw material mixture may further include a raw second extender component.

According to still other embodiments, the raw second extender component may include compounds with at least two isocyanate reactive groups such as 1,4-butylene glycol, diethylene glycol, diethanolamine, ethylene diamine, triethylene glycol, dipropylene glycol, or tri propylene glycol.

According to certain embodiments, the raw material mixture may include a particular content of raw second extender component. For example, the raw material mixture may include a content of the raw second extender component of at least about 0.1 wt. % for a total weight of the raw material mixture, such as, at least about 0.2 wt. % or at least about 0.3 wt. % or at least about 0.4 wt. % or even at least about 0.5 wt. % or at least about 0.6 wt. % or at least about 0.7 wt. % or at least about 0.8 wt. % or at least about 0.9 wt. % or even at least about 1.0 wt. %. According to yet other embodiments, the raw material mixture may include a content of the raw second extender component of not greater than about 2.0 wt. % for a total weight of the raw material mixture, such as, not greater than about 1.9 wt. % or not greater than about 1.8 wt. % or not greater than about 1.7 wt. % or not greater than about 1.6 wt. % or not greater than about 1.5 wt. % or not greater than about 1.4 wt. % or even not greater than about 1.3 wt. %. It will be appreciated that the content of the raw second extender component in the raw material mixture may be within a range between any of the minimum and maximum values noted above. It will be further appreciated that the content of the raw second extender component in the raw material mixture may be any value between any of the minimum and maximum values noted above.

According to still other embodiments, the raw material mixture may further include a raw surfactant component.

According to still other embodiments, the raw surfactant component may include any surfactant suitable for mechanical foaming, such as polydimethylsiloxane, polycyclomethicone, polysiloxane-olefin oxide copolymer, cationic silicone surfactant, anionic silicone surfactant, amphoteric silicone surfactant, or any combination thereof.

According to certain embodiments, the raw material mixture may include a particular content of raw surfactant component. For example, the raw material mixture may include a content of the raw surfactant component of at least about 0.1 wt. % for a total weight of the raw material mixture, such as, at least about 0.25 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to yet other embodiments, the raw material mixture may include a content of the raw surfactant component of not greater than about 7 wt. % for a total weight of the raw material mixture, such as, not greater than about 6.5 wt. % or not greater than about 6.0 wt. % or not greater than about 5.5 wt. % or not greater than about 5.0 wt. % or not greater than about 4.5 wt. % or not greater than about 4.0 wt. % or not greater than about 3.5 wt. % or even not greater than about 3.0 wt. %. It will be appreciated that the content of the raw surfactant component in the raw material mixture may be within a range between any of the minimum and maximum values noted above. It will be further appreciated that the content of the raw surfactant component in the raw material mixture may be any value between any of the minimum and maximum values noted above.

According to still other embodiments, the raw material mixture may further include a raw catalyst component.

According to still other embodiments, the raw catalyst component may include any thermal sensitive catalyst suitable for mechanical foaming, such as metal catalysts containing metal components, such as tin, cooper, lead, zinc, cobalt, or nickel, and amine catalysts such as tertiary amine or quaternary ammonium salt.

According to certain embodiments, the raw material mixture may include a particular content of raw catalyst component. For example, the raw material mixture may include a content of the raw catalyst component of at least about 0.05 wt. % for a total weight of the raw material mixture, such as, at least about 0.1 wt. % or at least about 0.25 wt. % or at least about 0.5 wt. % or at least about 0.75 wt. % or at least about 1.0 wt. % or at least about 1.25 wt. % or even at least about 1.5 wt. %. According to yet other embodiments, the raw material mixture may include a content of the raw catalyst component of not greater than about 4 wt. % for a total weight of the raw material mixture, such as, not greater than about 3.75 wt. % or not greater than about 3.5 wt. % or not greater than about 3.25 wt. % or not greater than about 3.0 wt. % or not greater than about 2.75 wt. % or not greater than about 2.5 wt. % or not greater than about 2.25 wt. % or even not greater than about 2.0 wt. %. It will be appreciated that the content of the raw catalyst component in the raw material mixture may be within a range between any of the minimum and maximum values noted above. It will be further appreciated that the content of the raw catalyst component in the raw material mixture may be any value between any of the minimum and maximum values noted above.

According to still other embodiments, the raw material mixture may further include a raw filler component, such as expandable graphite, glass beads, aluminum hydroxide and calcium carbonate or any combination thereof.

According to certain embodiments, the raw material mixture may include a particular content of raw filler component. For example, the raw material mixture may include a content of the raw filler component of at least about 0.01 wt. % for a total weight of the raw material mixture, such as, at least about 0.10 wt. % or at least about 0.25 wt. % or at least about 0.5 wt. % or at least about 0.75 wt. % or at least about 1.0 wt. % or at least about 1.25 wt. % or even at least about 1.5 wt. %. According to yet other embodiments, the raw material mixture may include a content of the raw filler component of not greater than about 40 wt. % for a total weight of the raw material mixture, such as, not greater than about 37 wt. % or not greater than about 35 wt. % or not greater than about 32 wt. % or not greater than about 30 wt. % or not greater than about 27 wt. % or not greater than about 25 wt. % or not greater than about 22 wt. % or not greater than about 20 wt. % or not greater than about 18 wt. % or not greater than about 15 wt. % or not greater than about 12 wt. % or not greater than about 10 wt. % or not greater than about 7 wt. % or not greater than about 5 wt. % or even not greater than about 3 wt. %. It will be appreciated that the content of the raw filler component in the raw material mixture may be within a range between any of the minimum and maximum values noted above. It will be further appreciated that the content of the raw filler component in the raw material mixture may be any value between any of the minimum and maximum values noted above.

According to yet other embodiments, forming the raw material mixture into a polyurethane foam may include foaming the raw material mixture to form a foamed material mixture. According to still other embodiments, forming the raw material mixture into a polyurethane foam may further include curing the foamed material mixture to form the polyurethane foam.

Referring now to the polyurethane foam formed according to embodiments described herein, the polyurethane foam may include a first polyol component, a second polyol component, and a polyether polyol component.

According to still other embodiments, the polyurethane foam may have at least two glass transition (Tg) peaks. A glass transition peak is defined as the distinct change observed on a thermal analysis graph that indicates the temperature range where a material moves through a phase transition, signifying the “glass transition temperature” (Tg) of the material. A glass transition peak usually appears as a step-like change in heat capacity as the material is heated through this transition phase. For purposes of embodiments described herein, a glass transition peak measured using a TA Instruments Q800 Dynamic Mechanical Analyzer, with testing parameters as follows: 1) tensile mode is used, 2) amplitude is set to 10 μm, 3) frequency is set to 1 Hz, 4) temperature scanning range is −50° C. to 150° C., and 5) heating rate is set to 3° C./min.

According to certain embodiments, the polyurethane foam may have a particular first glass transition peak Tg1. For example, the polyurethane foam may have a first glass transition peak located Tg1 at a temperature of not greater than about 50° C., such as, not greater than about 48° C. or not greater than about 45° C. or not greater than about 43° C. or not greater than about 40° C. or not greater than about 38° C. or not greater than about 35° C. or not greater than about 33° C. or even not greater than about 30° C. It will be appreciated that the polyurethane foam may have a first glass transition peak located at a temperature within a range between any of the values noted above. It will be further appreciated that the polyurethane foam may have a first glass transition peak located at a temperature between any of the minimum and maximum values noted above.

According to certain embodiments, the polyurethane foam may have a particular second glass transition peak Tg2. For example, the polyurethane form may have a second glass transition peak Tg2 located at a temperature of at least about 50° C., such as, at least about 53° C. or at least about 55° C. or at least about 58° C. or even at least about 60° C. According to still other embodiments, the polyurethane foam may hac a second glass transition peak Tg2 of not greater than about 100° C., such as, not greater than about 98° C. or not greater than about 95° C. or not greater than about 93° C. or not greater than about 90° C. or not greater than about 88° C. or not greater than about 85° C. or not greater than about 83° C. or even not greater than about 80° C. It will be appreciated that the polyurethane foam may have a second glass transition peak located at a temperature within a range between any of the values noted above. It will be further appreciated that the polyurethane foam may have a second glass transition peak located at a temperature between any of the minimum and maximum values noted above.

According to certain embodiments, the polyurethane foam may have a particular third glass transition peak Tg3. For example, the polyurethane foam may have a third glass transition peak Tg3 located at a temperature of at least about 100° C., such as, at least about 103° C. or at least about 105° C. or at least about 108° C. or even at least about 110° C. It will be appreciated that the polyurethane foam may have a third glass transition peak located at a temperature within a range between any of the values noted above. It will be further appreciated that the polyurethane foam may have a third glass transition peak located at a temperature between any of the minimum and maximum values noted above.

According to still other embodiments, the polyurethane foam may have a particular density as measured according to ASTM #D3574. For example, the polyurethane foam may have a density of at least about 50 kg/m³, such as, at least about 60 kg/m³ or at least about 70 kg/m³ or at least about 80 kg/m³ or at least about 90 kg/m³ or at least about 95 kg/m³ or at least about 100 kg/m³ or at least about 125 kg/m³ or at least about 150 kg/m³ or at least about 175 kg/m³ or at least about 200 kg/m³ or at least about 225 kg/m³ or even at least about 250 kg/m³. According to still other embodiments, the polyurethane foam may have a density of not greater than about 500 kg/m³, such as, not greater than about 490 kg/m³ or not greater than about 480 kg/m³ or not greater than about 470 kg/m³ or not greater than about 460 kg/m³ or not greater than about 450 kg/m³ or not greater than about 440 kg/m³ or not greater than about 430 kg/m³ or not greater than about 420 kg/m³ or not greater than about 410 kg/m³ or not greater than about 400 kg/m³. It will be appreciated that the density of the polyurethane foam may be within a range between any of the minimum and maximum values noted above. It will be further appreciated that the density of the polyurethane foam may be any value between any of the minimum and maximum values noted above.

According to other embodiments, the polyurethane foam may have a particular adjusted compression force deflection to density ratio, where the adjusted compression force deflection to density ratio is equal to CFD70/(D\hat{ }6), where the CFD70 is equal to the compression force deflection of the polyurethane foam in Pa measured at 23° C., 70% compressive strain, and D is equal to the density of the polyurethane foam in kg/m³. For purposes of embodiments described herein, the CFD70 is measured using an Instron 3367 Universal Testing System with the parameters: 1) a 1 inch² foam sample with thickness of about 6 mm, 2) a compression speed is 1 mm/min up to 70% compression strain, 3) record the stress (CFD70) after holding for 60 seconds. For example, the polyurethane foam may have an adjusted compression force deflection to density ratio of at least about 0.3, such as, at least about 0.4 or at least about 0.5 or at least about 0.6 or at least about 0.7. According to still other embodiments, the polyurethane foam may have an adjusted compression force deflection to density ratio of not greater than about 2.5, such as, not greater than about 2.3. It will be appreciated that the adjusted compression force deflection to density ratio of the polyurethane foam may be within a range between any of the minimum and maximum values noted above. It will be further appreciated that the adjusted compression force deflection to density ratio of the polyurethane foam may be any value between any of the minimum and maximum values noted above.

According to other embodiments, the polyurethane foam may have a particular a ratio PF_{CFD}/P_{FFTC50}, where PF_{CFD} is equal to the compression force deflection (CFD) of the polyurethane foam and PF_{FTC50} is equal to the force to compress (FTC) of the polyurethane foam. Generally, higher the value of PF_{CFD}/P_{FFTC50}, higher speed of recovery after compression. For purposes of embodiments described herein, the PF_{CFD} and PF_{FTC50} are measured using an Instron 3367 Universal Testing System with the parameters: 1) a 1 inch² foam sample with thickness of about 6 mm, 2) a compression speed is 1 mm/min up to 50% compression strain, 3) record the stress (P_{FFTC50}) when the target strain is reached and the stress (PF_{CFD}) after holding for 60 seconds. According to particular embodiments, the polyurethane foam may have a ratio PF_{CFD}/P_{FFTC50} of at least about 0.5, such as, at least about 0.6 or at least about 0.7 or at least about 0.8 or at least about 0.9. It will be appreciated that the ratio PF_{CFD}/PF_{FTC50} may be within a range between any of the values noted above. It will be further appreciated that the ratio PF_{CFD}/P_{FFTC50} may be any value between any of the values noted above.

According to yet other embodiments, the polyurethane foam may have a particular compression set (C-set). For purposes of embodiments described herein, the C-set is measured based on ASTM 3574. The compression strain is 50%. The testing temperature is 70° C., and the testing time is 7 days. For example, the polyurethane foam may have a C-set of not greater than about 40%, such as, not greater than about 38% or not greater than about 36% or not greater than about 34% or not greater than about 32% or not greater than about 30% or not greater than about 29% or not greater than about 28% or not greater than about 27% or not greater than about 26% or not greater than about 25% or not greater than about 24% or not greater than about 23% or not greater than about 22% or not greater than about 21% or even not greater than about 20%. It will be appreciated that the polyurethane foam may have a C-set within a range between any of the values noted above. It will be further appreciated that the polyurethane foam may have a C-set of any value between any of the values noted above.

According to certain embodiments, the polyurethane foam may include a particular content of first polyol component. For example, the polyurethane foam may include a content of the first polyol component of at least about 30 wt. % for a total weight of the polyurethane foam, such as, at least about 32 wt. % or at least about 33 wt. % or at least about 34 wt. % or at least about 35 wt. % or at least about 36 wt. % or at least about 37 wt. % or at least about 38 wt. % or at least about 39 wt. % or at least about 40 wt. % or at least about 41 wt. % or at least about 42 wt. % or at least about 43 wt. % or even at least about 44 wt. %. According to yet other embodiments, the polyurethane foam may include a content of the first polyol component of not greater than about 60 wt. % for a total weight of the polyurethane foam, such as, not greater than about 58 wt. % or not greater than about 55 wt. % or not greater than about 53 wt. % or not greater than about 50 wt. % or not greater than about 48 wt. % or even not greater than about 46 wt. %. It will be appreciated that the content of the first polyol component in the polyurethane foam may be within a range between any of the minimum and maximum values noted above. It will be further appreciated that the content of the first polyol component in the polyurethane foam may be any value between any of the minimum and maximum values noted above.

According to yet other embodiments, the first polyol component may have a particular hydroxyl value. For example, the first polyol component may have a hydroxyl value of at least about 18 mgKOH·g⁻¹, such as, at least about 19 mgKOH·g⁻¹ or at least about 21 mgKOH·g⁻¹ or at least about 23 mgKOH·g⁻¹ or at least about 25 mgKOH·g⁻¹ or at least about 37 mgKOH·g⁻¹ or at least about 30 mgKOH·g⁻¹ or at least about 33 mgKOH·g⁻¹ or even at least about 35 mgKOH·g⁻¹ or even at least about 37 mgKOH·g⁻¹ or even at least about 39 mgKOH·g⁻¹. According to still other embodiments, the first polyol component may have a hydroxyl value of not greater than about 60 mgKOH·g⁻¹, such as, not greater than about 57 mgKOH·g⁻¹ or not greater than about 55 mgKOH·g⁻¹ or not greater than about 53 mgKOH·g⁻¹ or not greater than about 50 mgKOH·g⁻¹ or not greater than about 47 KOH mgKOH·g⁻¹ or not greater than about 45 mgKOH·g⁻¹ or even not greater than about 43 mgKOH·g⁻¹. It will be appreciated that the hydroxyl value of the first polyol component may be within a range between any of the minimum and maximum values noted above. It will be further appreciated that the hydroxyl value of the first polyol component may be any value between any of the minimum and maximum values noted above.

According to still other embodiments, the first polyol component may include polyether polyol components. According to still other embodiments, the first polyol component may be a propylene oxide (PO) end capped polyol component. According to yet other embodiments, the first polyol component may contain substantially no ethylene oxide (EO).

According to yet other embodiments, the first polyol component may have a particular functionality. For example, the first polyol component may have a functionality of at least 2, such as, at least 2.5 or at least 3 or at least 3.5 or at least 4 or even at least 5. According to still other embodiments, the first polyol component may have a functionality of not greater than about 6, such as, not greater than about 5.5 or even not greater than about 5. It will be appreciated that the functionality of the first polyol component may be within a range between any of the minimum and maximum values noted above. It will be further appreciated that the functionality of the first polyol component may be any value between any of the minimum and maximum values noted above.

According to other embodiments, the first polyol component may have a particular molecular mass. For example, the first polyol component may have a molecular mass of at least about 2000 g/mol, such as, at least about 2200 g/mol or at least about 2400 g/mol or at least about 2600 g/mol or at least about 2700 g/mol or at least about 2800 g/mol or at least about 2900 g/mol or even at least about 3000 g/mol. According to still other embodiments, the first polyol component may have a molecular mass of not greater than about 8000 g/mol, such as, not greater than about 7000 g/mol or not greater than about 6000 g/mol or not greater than about 5000 g/mol or not greater than about 4500 g/mol or not greater than about 4000 g/mol or not greater than about 3900 g/mol or not greater than about 3800 g/mol or not greater than about 3700 g/mol or not greater than about 3600 g/mol or not greater than about 3500 g/mol or not greater than about 3400 g/mol or not greater than about 3300 g/mol or not greater than about 3200 g/mol or even not greater than about 3100 g/mol. It will be appreciated that the molecular mass of the first polyol component may be within a range between any of the minimum and maximum values noted above. It will be further appreciated that the molecular mass of the first polyol component may be any value between any of the minimum and maximum values noted above.

According to yet other embodiments, the first polyol component may have a particular solid content by weight. For example, the first polyol component may have a solid content by weight of at least about 1.0 wt. %, such as, at least about 3.0 wt. % or at least about 5.0 wt. % or at least about 10.0 wt. % or at least about 15.0 wt. % or at least about 20.0 wt. % or at least about 25.0 wt. % or at least about 30.0 wt. % or at least about 35.0 wt. % or at least about 40.0 wt. % or at least about 43.5 wt. % or at least about 44.0 wt. % or at least about 44.5 wt. % or even at least about 45.0 wt. %. According to still other embodiments, the first polyol component may have a solid content by weight of not greater than about 50.0 wt. %, such as, not greater than about 49.5 wt. % or not greater than about 49.0 wt. % or not greater than about 48.5 wt. % or not greater than about 48.0 wt. % or not greater than about 47.5 wt. %. It will be appreciated that the solid content by weight of the first polyol component may be within a range between any of the minimum and maximum values noted above. It will be further appreciated that the solid content by weight of the first polyol component may be any value between any of the minimum and maximum values noted above.

According to particular embodiments, suitable solid organic fillers making up the solid content of the first polyol may include styrene/acrylonitrile (SAN) particles prepared by free radical polymerization of monomers (i.e., styrene and acrylonitrile), PHD polyurea (formed in situ by polymerization of a diamine and an isocyanate), or PIPA (polyisocyanate polyaddition formed by reaction of an alkanolamine with an isocyanate). According to other embodiments, suitable solid organic fillers making up the solid content of the first polyol may consist essentially of styrene/acrylonitrile (SAN) particles prepared by free radical polymerization of monomers (i.e., styrene and acrylonitrile), PHD polyurea (formed in situ by polymerization of a diamine and an isocyanate), or PIPA (polyisocyanate polyaddition formed by reaction of an alkanolamine with an isocyanate).

According to certain embodiments, the polyurethane foam may include a particular content of second polyol component. For example, the polyurethane foam may include a content of the second polyol component of at least about 3 wt. % for a total weight of the polyurethane foam, such as, at least about 4 wt. % or at least about 5 wt. % or at least about 6 wt. % or at least about 7 wt. % or at least about 8 wt. % or at least about 9 wt. % or at least about 10 wt. % or at least about 11 wt. % or even at least about 12 wt. %. According to yet other embodiments, the polyurethane foam may include a content of the second polyol component of not greater than about 25 wt. % for a total weight of the polyurethane foam, such as, not greater than about 24 wt. % or not greater than about 23 wt. % or not greater than about 22 wt. % or even not greater than about 21 wt. % or even not greater than about 20 wt. % or even not greater than about 19 wt. % or even not greater than about 18 wt. % or even not greater than about 17 wt. % or even not greater than about 16 wt. % or even not greater than about 15 wt. %. It will be appreciated that the content of the second polyol component in the polyurethane foam may be within a range between any of the minimum and maximum values noted above. It will be further appreciated that the content of the second polyol component in the polyurethane foam may be any value between any of the minimum and maximum values noted above.

According to yet other embodiments, the second polyol component may have a particular hydroxyl value. For example, the second polyol component may have a hydroxyl value of at least about 150 mgKOH·g⁻¹, such as, at least about 170 mgKOH·g⁻¹ or at least about 190 mgKOH·g⁻¹ or at least about 200 mgKOH·g⁻¹ or at least about 205 mgKOH·g⁻¹ or at least about 210 mgKOH·g⁻¹ or at least about 215 mgKOH·g⁻¹ or at least about 220 mgKOH·g⁻¹ or even at least about 225 mgKOH·g⁻¹. According to still other embodiments, the second polyol component may have a hydroxyl value of not greater than about 300 mgKOH·g⁻¹, such as, not greater than about 280 mgKOH·g⁻¹ or not greater than about 260 mgKOH·g⁻¹ or not greater than about 250 mgKOH·g⁻¹ or not greater than about 245 mgKOH·g⁻¹ or not greater than about 240 mgKOH·g⁻¹ or not greater than about 235 mgKOH·g⁻¹ or not greater than about 230 mgKOH·g⁻¹ or even not greater than about 228 mgKOH·g⁻¹. It will be appreciated that the hydroxyl value of the second polyol component may be within a range between any of the minimum and maximum values noted above. It will be further appreciated that the hydroxyl value of the second polyol component may be any value between any of the minimum and maximum values noted above.

According to still other embodiments, the second polyol component may have a particular functionality. For example, the second polyol component may have a functionality of at least about 1, such as, at least about 2 or even at least about 3. According to still other embodiments, the second polyol component may have a functionality of not greater than about 6, such as, not greater than about 5 or even not greater than about 4. It will be appreciated that the functionality of the second polyol component may be within a range between any of the minimum and maximum values noted above. It will be further appreciated that the functionality of the second polyol component may be any value between any of the minimum and maximum values noted above.

According to other embodiments, the second polyol component may have a particular molecular mass. For example, the second polyol component may have a molecular mass of at least about 400 g/mol, such as, at least about 410 g/mol or at least about 420 g/mol or at least about 430 g/mol or at least about 440 g/mol or at least about 450 g/mol or at least about 460 g/mol or even at least about 470 g/mol. According to still other embodiments, the second polyol component may have a molecular mass of not greater than about 1200 g/mol, such as, not greater than about 1150 g/mol or not greater than about 1100 g/mol or not greater than about 1000 g/mol or not greater than about 950 g/mol or not greater than about 900 g/mol or not greater than about 850 g/mol or not greater than about 800 g/mol or not greater than about 750 g/mol or even not greater than about 700 g/mol or even not greater than about 650 g/mol or even not greater than about 600 g/mol. It will be appreciated that the molecular mass of the second polyol component may be within a range between any of the minimum and maximum values noted above. It will be further appreciated that the molecular mass of the second polyol component may be any value between any of the minimum and maximum values noted above.

According to certain embodiments, the polyurethane foam may include a particular content of the isocyanate component. For example, the polyurethane foam may include a content of the isocyanate component of at least about 22.0 wt. % for a total weight of the polyurethane foam, such as, at least about 23 wt. % or at least about 24 wt. % or at least about 25 wt. % or at least about 26 wt. % or at least about 27 wt. % or at least about 28 wt. % or at least about 29 wt. % or even at least about 30 wt. %. According to yet other embodiments, the polyurethane foam may include a content of the isocyanate component of not greater than about 50 wt. % for a total weight of the polyurethane foam, such as, not greater than about 49 wt. % or not greater than about 48 wt. % or not greater than about 47 wt. % or not greater than about 46 wt. % or not greater than about 45 wt. % or not greater than about 44 wt. % or not greater than about 43 wt. % or not greater than about 42 wt. % or not greater than about 41 wt. % or even not greater than about 40 wt. %. It will be appreciated that the content of the isocyanate component in the polyurethane foam may be within a range between any of the minimum and maximum values noted above. It will be further appreciated that the content of the isocyanate component in the polyurethane foam may be any value between any of the minimum and maximum values noted above.

According to still other embodiments, the isocyanate component may include 2,4-toluene diisocyanate (2,4-TDI), 2,6-toluene diisocyanate (2,6-TDI), hexamethylenediisocyanate (HDI), isophorone-diisocyanate (IPDI), 4,4′-Diphenylmethane diisocyanate (4,4′-MDI), 2,4′-Diphenylmethane diisocyanate (2,4′-MDI), Polymeric MDI (PMDI), 4,4′-Dicyclohexylmethane diisocyanate (HMDI). Other various isocyanate forms derivatives may be used such as uretidinedione or uretonimine-linked isocyanates.

According to still other embodiments, the isocyanate component may have a particular functionality. For example, the isocyanate component may have a functionality of at least about 2, such as, at least about 3. According to still other embodiments, the isocyanate component may have a functionality of not greater than about 6, such as, not greater than about 5 or even not greater than about 4. It will be appreciated that the functionality of the isocyanate component may be within a range between any of the minimum and maximum values noted above. It will be further appreciated that the functionality of the isocyanate component may be any value between any of the minimum and maximum values noted above.

According to still other embodiments, the polyurethane foam may further include a first extender component.

According to still other embodiments, the first extender component may include compounds with at least two isocyanate reactive groups such as 1,4-butylene glycol, diethylene glycol, diethanolamine, ethylene diamine, triethylene glycol, dipropylene glycol, or tri propylene glycol.

According to certain embodiments, the polyurethane foam may include a particular content of the first extender component. For example, the polyurethane foam may include a content of the first extender component of at least about 0.1 wt. % for a total weight of the polyurethane foam, such as, at least about 0.3 wt. % or at least about 0.5 wt. % or at least about 0.75 wt. % or at least about 1.0 wt. % or at least about 1.25 wt. % or at least about 1.5 wt. % or at least about 1.75 wt. % or even at least about 2 wt. %. According to yet other embodiments, the polyurethane foam may include a content of the first extender component of not greater than about 6.0 wt. % for a total weight of the polyurethane foam, such as, not greater than about 5.5 wt. % or not greater than about 5.0 wt. % or not greater than about 4.5 wt. % or not greater than about 4.0 wt. % or not greater than about 3.5 wt. % or not greater than about 3 wt. % or even not greater than about 2.5 wt. %. It will be appreciated that the content of the first extender component in the polyurethane foam may be within a range between any of the minimum and maximum values noted above. It will be further appreciated that the content of the first extender component in the polyurethane foam may be any value between any of the minimum and maximum values noted above.

According to still other embodiments, the polyurethane foam may further include a second extender component.

According to still other embodiments, the second extender component may include compounds with at least two isocyanate reactive groups such as 1,4-butylene glycol, diethanolamine, ethylene diamine, diethylene glycol, triethylene glycol, dipropylene glycol, or tri propylene glycol.

According to certain embodiments, the polyurethane foam may include a particular content of the second extender component. For example, the polyurethane foam may include a content of the second extender component of at least about 0.1 wt. % for a total weight of the polyurethane foam, such as, at least about 0.2 wt. % or at least about 0.3 wt. % or at least about 0.4 wt. % or even at least about 0.5 wt. % or at least about 0.6 wt. % or at least about 0.7 wt. % or at least about 0.8 wt. % or at least about 0.9 wt. % or even at least about 1.0 wt. %. According to yet other embodiments, the polyurethane foam may include a content of the second extender component of not greater than about 2.0 wt. % for a total weight of the polyurethane foam, such as, not greater than about 1.9 wt. % or not greater than about 1.8 wt. % or not greater than about 1.7 wt. % or not greater than about 1.6 wt. % or not greater than about 1.5 wt. % or not greater than about 1.4 wt. % or even not greater than about 1.3 wt. %. It will be appreciated that the content of the second extender component in the polyurethane foam may be within a range between any of the minimum and maximum values noted above. It will be further appreciated that the content of the second extender component in the polyurethane foam may be any value between any of the minimum and maximum values noted above.

According to still other embodiments, the polyurethane foam may further include a surfactant component.

According to still other embodiments, the surfactant component may include any surfactant suitable for mechanical foaming, such as, polydimethylsiloxane, polycyclomethicone, polysiloxane-olefin oxide copolymer, cationic silicone surfactant, anionic silicone surfactant, amphoteric silicone surfactant, or any combination thereof.

According to certain embodiments, the polyurethane foam may include a particular content of surfactant component. For example, the polyurethane foam may include a content of the surfactant component of at least about 0.1 wt. % for a total weight of the polyurethane foam, such as, at least about 0.25 wt. % or at least about 0.5 wt. % or at least about 0.75 wt. % or at least about 1.0 wt. % or at least about 1.25 wt. % or at least about 1.5 wt. % or at least about 1.75 wt. % or at least about 2.0 wt. % or at least about 2.25 wt. % or even at least about 2.5 wt. %. According to yet other embodiments, the polyurethane foam may include a content of the surfactant component of not greater than about 7 wt. % for a total weight of the polyurethane foam, such as, not greater than about 6.5 wt. % or not greater than about 6.0 wt. % or not greater than about 5.5 wt. % or not greater than about 5.0 wt. % or not greater than about 4.5 wt. % or not greater than about 4.0 wt. % or not greater than about 3.5 wt. % or even not greater than about 3.0 wt. %. It will be appreciated that the content of the surfactant component in the polyurethane foam may be within a range between any of the minimum and maximum values noted above. It will be further appreciated that the content of the surfactant component in the polyurethane foam may be any value between any of the minimum and maximum values noted above.

According to still other embodiments, the polyurethane foam may further include a catalyst component.

According to still other embodiments, the catalyst component may include any thermal sensitive catalyst suitable for mechanical foaming, such as metal catalysts containing metal components, such as tin, cooper, lead, zinc, cobalt, or nickel, and amine catalysts such as tertiary amine or quaternary ammonium salt.

According to certain embodiments, the polyurethane foam may include a particular content of catalyst component. For example, the polyurethane foam may include a content of the catalyst component of at least about 0.05 wt. % for a total weight of the polyurethane foam, such as, at least about 0.1 wt. % or at least about 0.25 wt. % or at least about 0.5 wt. % or at least about 0.75 wt. % or at least about 1.0 wt. % or at least about 1.25 wt. % or even at least about 1.5 wt. %. According to yet other embodiments, the polyurethane foam may include a content of the catalyst component of not greater than about 4 wt. % for a total weight of the polyurethane foam, such as, not greater than about 3.75 wt. % or not greater than about 3.5 wt. % or not greater than about 3.25 wt. % or not greater than about 3.0 wt. % or not greater than about 2.75 wt. % or not greater than about 2.5 wt. % or not greater than about 2.25 wt. % or even not greater than about 2.0 wt. %. It will be appreciated that the content of the catalyst component in the polyurethane foam may be within a range between any of the minimum and maximum values noted above. It will be further appreciated that the content of the catalyst component in the polyurethane foam may be any value between any of the minimum and maximum values noted above.

According to still other embodiments, the polyurethane foam may further include a filler component, such as expandable graphite, glass beads, aluminum hydroxide and calcium carbonate or any combination thereof.

According to certain embodiments, the polyurethane foam may include a particular content of filler component. For example, the polyurethane foam may include a content of the filler component of at least about 0.01 wt. % for a total weight of the polyurethane foam, such as, at least about 0.10 wt. % or at least about 0.25 wt. % or at least about 0.5 wt. % or at least about 0.75 wt. % or at least about 1.0 wt. % or at least about 1.25 wt. % or even at least about 1.5 wt. %. According to yet other embodiments, the polyurethane foam may include a content of the filler component of not greater than about 40 wt. % for a total weight of the polyurethane foam, such as, not greater than about 37 wt. % or not greater than about 35 wt. % or not greater than about 32 wt. % or not greater than about 30 wt. % or not greater than about 27 wt. % or not greater than about 25 wt. % or not greater than about 22 wt. % or not greater than about 20 wt. % or not greater than about 18 wt. % or not greater than about 15 wt. % or not greater than about 12 wt. % or not greater than about 10 wt. % or not greater than about 7 wt. % or not greater than about 5 wt. % or even not greater than about 3 wt. %. It will be appreciated that the content of the filler component in the polyurethane foam may be within a range between any of the minimum and maximum values noted above. It will be further appreciated that the content of the filler component in the polyurethane foam may be any value between any of the minimum and maximum values noted above.

According to yet other embodiments, the polyurethane foam may have a particular thickness. For example, the polyurethane foam may have a thickness of at least about 0.5 mm, such as, at least about 0.55 mm or at least about 0.6 mm or at least about 0.65 mm or at least about 0.7 mm or even at least about 0.75 mm. According to still other embodiments, the polyurethane foam may have a thickness of not greater than about 15 mm, such as, not greater than about 14.5 mm or not greater than about 14.0 mm or not greater than about 13.5 mm or not greater than about 13.0 mm or not greater than about 12.5 mm or not greater than about 12.0 mm or not greater than about 11.5 mm or not greater than about 11.0 mm or not greater than about 10.5 mm or not greater than about 10.0 mm or not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.5 mm or not greater than about 2.0 mm or not greater than about 1.5 mm or even not greater than about 1.0 mm. It will be appreciated that the thickness of the polyurethane foam may be within a range between any of the minimum and maximum values noted above. It will be further appreciated that the thickness of the polyurethane foam may be any value between any of the minimum and maximum values noted above.

Referring now to a particular use of the polyurethane foam formed according to embodiments described herein, a particular embodiment may include a battery compression pad that may include a polyurethane foam. It will be appreciated that the polyurethane foam of the battery compression pad may be formed according to any of the embodiments described herein. It will be further appreciated that the polyurethane foam of the battery compression pad may include any of the components described in reference to any of the embodiments described herein. It will be still further appreciated that the polyurethane foam of the battery compression pad may include any of the characteristics described in reference to embodiments described herein.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A polyurethane foam comprising: a first polyol component comprising a polyether polyol component, a second polyol component comprising a polycaprolactone polyol component, and an isocyanate component, wherein the polyurethane foam comprises at least two distinct glass transition (Tg) peaks.

Embodiment 2. A polyurethane foam comprising a reaction product of a raw mixture, wherein the raw material mixture comprises: a raw first polyol component comprising a polyether polyol component, a raw second polyol component comprising a polycaprolactone polyol component, and a raw isocyanate component, wherein the polyurethane foam comprises at least two distinct glass transition (Tg) peaks.

Embodiment 3. A method of forming a polyurethane foam comprising: providing a raw material mixture comprising: a raw first polyol component comprising a polyether polyol component, a raw second polyol component comprising a polycaprolactone polyol component, and a raw isocyanate component, and forming the raw material mixture into a polyurethane foam, wherein the polyurethane foam comprises at least two distinct glass transition (Tg) peaks.

Embodiment 4. The polyurethane foam or method of any one of embodiments 1, 2, and 3, wherein the polyurethane foam comprises a first glass transition peak Tg1 located at a temperature of not greater than about 50° C.

Embodiment 5. The polyurethane foam or method of any one of embodiments 1, 2, and 3, wherein the polyurethane foam comprises a second glass transition peak Tg2 located at a temperature of at least about 50° C.

Embodiment 6. The polyurethane foam or method of any one of embodiments 1, 2, and 3, wherein the polyurethane foam comprises a second glass transition peak Tg2 located at a temperature of not greater than about 100° C.

Embodiment 7. The polyurethane foam or method of any one of embodiments 1, 2, and 3, wherein the polyurethane foam further comprises a third glass transition peak Tg3 located at a temperature of at least about 100° C.

Embodiment 8. The polyurethane foam or method of any one of embodiments 1, 2, and 3, wherein the polyurethane foam comprises a density of at least about 50 kg/m³.

Embodiment 9. The polyurethane foam or method of any one of embodiments 1, 2, and 3, wherein the polyurethane foam comprises a density of not greater than about 500 kg/m³.

Embodiment 10. The polyurethane foam or method of any one of embodiments 1, 2, and 3, wherein the polyurethane foam comprises a ratio PF_{CFD}/PF_{D}\hat{ }2.6 of at least about 0.3, where PF_{CFD} is equal to the compression force deflection (CFD) of the polyurethane foam and PF_{D} is equal to the density of the polyurethane foam.

Embodiment 11. The polyurethane foam or method of any one of embodiments 1, 2, and 3, wherein the polyurethane foam comprises a ratio PF_{CFD}/PF_{FTC50} of at least about 0.5, where PF_{CFD} is equal to the compression force deflection (CFD) of the polyurethane foam and P_{FFTC50} is equal to the force to compress (FTC) of the polyurethane foam.

Embodiment 12. The polyurethane foam or method of any one of embodiments 1, 2, and 3, wherein the polyurethane foam comprises C-set of not greater than about 40%.

Embodiment 13. The polyurethane foam of embodiment 1, wherein the polyurethane foam comprises a first polyol component content of at least about 30 wt. % for a total weight of the polyurethane foam.

Embodiment 14. The polyurethane foam of embodiment 1, wherein the polyurethane foam comprises a first polyol component content of not greater than about 60 wt. % for a total weight of the polyurethane foam.

Embodiment 15. The polyurethane foam of embodiment 1, wherein the first polyol component comprises a hydroxyl value of at least about 18 mgKOH·g−1.

Embodiment 16. The polyurethane foam of embodiment 1, wherein the first polyol component comprises a hydroxyl value of not greater than about at least about 60 mgKOH·g−1.

Embodiment 17. The polyurethane foam of embodiment 1, wherein the first polyol component comprises a molecular weight of at least about 2000 g/mol.

Embodiment 18. The polyurethane foam of embodiment 1, wherein the first polyol component comprises a molecular weight of not greater than about 8000 g/mol.

Embodiment 19. The polyurethane foam of embodiment 1, wherein the first polyol component comprises a solid content of at least about 1 wt. %.

Embodiment 20. The polyurethane foam of embodiment 1, wherein the first polyol component comprises a solid content of not greater than about 50 wt. %.

Embodiment 21. The polyurethane foam of embodiment 1, wherein the first polyol component comprises a functionality of at least about 2 and not greater than about 6.

Embodiment 22. The polyurethane foam of embodiment 1, wherein the polyurethane foam comprises a second polyol component content of at least about 3 wt. % for a total weight of the polyurethane foam.

Embodiment 23. The polyurethane foam of embodiment 1, wherein the polyurethane foam comprises a second polyol component content of not greater than about 25 wt. % for a total weight of the polyurethane foam.

Embodiment 24. The polyurethane foam of embodiment 1, wherein the second polyol component comprises a hydroxyl value of at least about 150 mgKOH·g−1.

Embodiment 25. The polyurethane foam of embodiment 1, wherein the second polyol component comprises a hydroxyl value of not greater than about at least about 300 mgKOH·g−1.

Embodiment 26. The polyurethane foam of embodiment 1, wherein the second polyol component comprises a molecular weight of at least about 400 g/mol.

Embodiment 27. The polyurethane foam of embodiment 1, wherein the second polyol component comprises a functionality of at least about 1 and not greater than about 6.

Embodiment 28. The polyurethane foam of embodiment 1, wherein the second polyol component comprises a polycaprolactone polyol component.

Embodiment 29. The polyurethane foam of embodiment 1, wherein the polyurethane foam comprises an isocyanate component content of at least about 22 wt. % for a total weight of the polyurethane foam.

Embodiment 30. The polyurethane foam of embodiment 1, wherein the polyurethane foam comprises an isocyanate component content of not greater than about 50 wt. % for a total weight of the polyurethane foam.

Embodiment 31. The polyurethane foam of embodiment 1, wherein the isocyanate comprises a prepolymer based MDI and PMDI.

Embodiment 33. The polyurethane foam of embodiment 1, wherein the isocyanate comprises a functionality of at least about 2 and not greater than about 6.

Embodiment 34. The polyurethane foam of embodiment 1, wherein the polyurethane foam further comprises a first chain extender component.

Embodiment 35. The polyurethane foam of embodiment 34, wherein the polyurethane foam comprises a first chain extender component content of at least about 0.1 wt. % for a total weight of the polyurethane foam.

Embodiment 36. The polyurethane foam of embodiment 34, wherein the polyurethane foam comprises a first chain extender component content of not greater than about 6 wt. % for a total weight of the polyurethane foam.

Embodiment 37. The polyurethane foam of embodiment 34, wherein the first chain extender comprises at least two isocyanate reactive groups.

Embodiment 38. The polyurethane foam of embodiment 1, wherein the polyurethane foam further comprises a second chain extender component.

Embodiment 39. The polyurethane foam of embodiment 38, wherein the polyurethane foam comprises a second chain extender component content of at least about 0.1 wt. % for a total weight of the polyurethane foam.

Embodiment 40. The polyurethane foam of embodiment 38, wherein the polyurethane foam comprises a second chain extender component content of not greater than about 2 wt. % for a total weight of the polyurethane foam.

Embodiment 41. The polyurethane foam of embodiment 38, wherein the second chain extender comprises at least two isocyanate reactive groups.

Embodiment 42. The polyurethane foam of embodiment 1, wherein the polyurethane foam further comprises a surfactant component.

Embodiment 43. The polyurethane foam of embodiment 42, wherein the polyurethane foam comprises a surfactant component content of at least about 0.1 wt. % for a total weight of the polyurethane foam.

Embodiment 44. The polyurethane foam of embodiment 42, wherein the polyurethane foam comprises a surfactant component content of not greater than about 7 wt. % for a total weight of the polyurethane foam.

Embodiment 45. The polyurethane foam of embodiment 42, wherein the surfactant comprises a surfactant suitable for mechanical foaming.

Embodiment 46. The polyurethane foam of embodiment 1, wherein the polyurethane foam further comprises a catalyst component.

Embodiment 47. The polyurethane foam of embodiment 46, wherein the polyurethane foam comprises a catalyst component content of at least about 0.05 wt. % for a total weight of the polyurethane foam.

Embodiment 48. The polyurethane foam of embodiment 46, wherein the polyurethane foam comprises a catalyst component content of not greater than about 4 wt. % for a total weight of the polyurethane foam.

Embodiment 49. The polyurethane foam of embodiment 46, wherein the catalyst comprises a thermal sensitive catalyst suitable for mechanical foaming.

Embodiment 50. The polyurethane foam of embodiment 1, wherein the polyurethane foam further comprises a filler component.

Embodiment 51. The polyurethane foam of embodiment 50, wherein the polyurethane foam comprises a filler component content of at least about 0.01 wt. % for a total weight of the polyurethane foam.

Embodiment 52. The polyurethane foam of embodiment 50, wherein the polyurethane foam comprises a filler component content of not greater than about 40 wt. % for a total weight of the polyurethane foam.

Embodiment 53. The polyurethane foam or method of any one of embodiments 2 and 3, the polyurethane foam comprises a raw first polyol component content of at least about 30 wt. % for a total weight of the raw material mixture.

Embodiment 54. The polyurethane foam or method of any one of embodiments 2 and 3, wherein the raw material mixture comprises a raw first polyol component content of not greater than about 60 wt. % for a total weight of the raw material mixture.

Embodiment 55. The polyurethane foam or method of any one of embodiments 2 and 3, wherein the raw first polyol component comprises a hydroxyl value of at least about 18 mgKOH·g⁻¹.

Embodiment 56. The polyurethane foam or method of any one of embodiments 2 and 3, wherein the raw first polyol component comprises a hydroxyl value of not greater than about at least about 60 mgKOH·g⁻¹.

Embodiment 57. The polyurethane foam or method of any one of embodiments 2 and 3, wherein the raw first polyol component comprises a molecular mass of at least about 2000 g/mol.

Embodiment 58. The polyurethane foam or method of any one of embodiments 2 and 3, wherein the raw first polyol component comprises a molecular mass of not greater than about 8000 g/mol.

Embodiment 59. The polyurethane foam or method of any one of embodiments 2 and 3, wherein the raw first polyol component comprises a solid content of at least about 1 wt. %.

Embodiment 60. The polyurethane foam or method of any one of embodiments 2 and 3, wherein the raw first polyol component comprises a solid content of not greater than about 50 wt. %.

Embodiment 61. The polyurethane foam or method of any one of embodiments 2 and 3, wherein the raw first polyol component comprises a functionality of at least about 2 and not greater than about 6.

Embodiment 62. The polyurethane foam or method of any one of embodiments 2 and 3, wherein the raw material mixture comprises a raw second polyol component content of at least about 3 wt. % for a total weight of the raw material mixture.

Embodiment 63. The polyurethane foam or method of any one of embodiments 2 and 3, wherein the raw material mixture comprises a raw second polyol component content of not greater than about 25 wt. % for a total weight of the raw material mixture.

Embodiment 64. The polyurethane foam or method of any one of embodiments 2 and 3, wherein the raw second polyol component comprises a hydroxyl value of at least about 150 mgKOH·g−1.

Embodiment 65. The polyurethane foam or method of any one of embodiments 2 and 3, wherein the raw second polyol component comprises a hydroxyl value of not greater than about at least about 300 mgKOH·g−1.

Embodiment 66. The polyurethane foam or method of any one of embodiments 2 and 3, wherein the raw second polyol component comprises a molecular mass of at least about 400 g/mol.

Embodiment 67. The polyurethane foam or method of any one of embodiments 2 and 3, wherein the raw second polyol component comprises a functionality of at least about 1 and not greater than about 6.

Embodiment 68. The polyurethane foam or method of any one of embodiments 2 and 3, wherein the raw second polyol component comprises a polycaprolactone polyol component.

Embodiment 69. The polyurethane foam or method of any one of embodiments 2 and 3, wherein the raw material mixture comprises a raw isocyanate component content of at least about 22 wt. % for a total weight of the raw material mixture.

Embodiment 70. The polyurethane foam or method of any one of embodiments 2 and 3, wherein the raw material mixture comprises a raw isocyanate component content of not greater than about 50 wt. % for a total weight of the raw material mixture.

Embodiment 71. The polyurethane foam or method of any one of embodiments 2, and 3, wherein the raw isocyanate comprises a prepolymer based MDI and PMDI.

Embodiment 72. The polyurethane foam or method of any one of embodiments 2 and 3, wherein the raw isocyanate comprises a functionality of at least about 2 and not greater than about 6.

Embodiment 73. The polyurethane foam or method of any one of embodiments 2 and 3, wherein the raw material mixture further comprises a raw first chain extender component.

Embodiment 74. The polyurethane foam or method of embodiment 73, wherein the raw material mixture comprises a raw first chain extender component content of at least about 0.1 wt. % for a total weight of the raw material mixture.

Embodiment 75. The polyurethane foam or method of embodiment 73, wherein the raw material mixture comprises a raw first chain extender component content of not greater than about 6 wt. % for a total weight of the raw material mixture.

Embodiment 76. The polyurethane foam or method of embodiment 73, wherein the raw first chain extender comprises at least two isocyanate reactive groups.

Embodiment 77. The polyurethane foam or method of any one of embodiments 2, and 3, wherein the raw material mixture further comprises a raw second chain extender component.

Embodiment 78. The polyurethane foam or method of embodiment 77, wherein the raw material mixture comprises a raw second chain extender component content of at least about 0.1 wt. % for a total weight of the raw material mixture.

Embodiment 79. The polyurethane foam or method of embodiment 77, wherein the raw material mixture comprises a raw second chain extender component content of not greater than about 2 wt. % for a total weight of the raw material mixture.

Embodiment 80. The polyurethane foam or method of embodiment 77, wherein the raw second chain extender comprises at least two isocyanate reactive groups.

Embodiment 81. The polyurethane foam or method of any one of embodiments 2 and 3, wherein the raw material mixture further comprises a raw surfactant component.

Embodiment 82. The polyurethane foam or method of embodiment 81, wherein the raw material mixture comprises a raw surfactant component content of at least about 0.1 wt. % for a total weight of the raw material mixture.

Embodiment 83. The polyurethane foam or method of embodiment 81, wherein the raw material mixture comprises a raw surfactant component content of not greater than about 7 wt. % for a total weight of the raw material mixture.

Embodiment 84. The polyurethane foam or method of embodiment 81, wherein the raw surfactant comprises a surfactant suitable for mechanical foaming.

Embodiment 85. The polyurethane foam or method of any one of embodiments 2 and 3, wherein the raw material mixture further comprises a raw catalyst component.

Embodiment 86. The polyurethane foam or method of embodiment 85, wherein the raw material mixture comprises a raw catalyst component content of at least about 0.05 wt. % for a total weight of the raw material mixture.

Embodiment 87. The polyurethane foam or method of embodiment 85, wherein the raw material mixture comprises a raw catalyst component content of not greater than about 4 wt. % for a total weight of the raw material mixture.

Embodiment 88. The polyurethane foam or method of embodiment 85, wherein the raw catalyst comprises a thermal sensitive catalyst suitable for mechanical foaming.

Embodiment 89. The polyurethane foam or method of any one of embodiments 2 and 3, wherein the raw material mixture further comprises a raw filler component.

Embodiment 90. The polyurethane foam or method of embodiment 89, wherein the raw material mixture comprises a raw filler component content of at least about 0.01 wt. % for a total weight of the raw material mixture.

Embodiment 91. The polyurethane foam or method of embodiment 89, wherein the raw material mixture comprises a raw filler component content of not greater than about 40 wt. % for a total weight of the raw material mixture.

### EXAMPLES

The concepts described herein will be further described in the following Examples, which do not limit the scope of the invention described in the claims.

### Example 1

Sample polyurethane foams S1-S6 were formed according to embodiments described herein and comparative samples CS1-CS4 were formed for comparison to the samples S1-S6.

For sample polyurethane foams S1, the polyol-1 is a polyether polyol with glycerol starting, a hydroxyl value of around 56 mgKOH·g−1, and a functionality of 3. For samples S2-S6, the polyol-1 is a polymer polyol (POP) with a traditional polyether polyol as based polyether, and a hydroxyl value of 28-32 mgKOH·g−1. For samples S1-S5, the polyol-2 is a polycaprolactone polyol with a DEG starting, a hydroxyl value of 204˜220 mgKOH·g−1, and a functionality of 3. For sample S6, the polyol-2 is a polycaprolactone polyol with a hydroxyl value of 216˜232 mgKOH·g−1, and a functionality of 4.

The compositions of sample polyurethane foams S1-S6 and comparative samples CS1-CS4 are summarized in Table 1 below.

TABLE 1
Sample Foam Compositions

| | S1 | S2 | S3 | S4 | S5 | S6 | CS1 | CS2 | CS3 | CS4 |
|---|---|---|---|---|---|---|---|---|---|---|
| | (wt. % | (wt. % | (wt. % | (wt. % | (wt. % | (wt. % | (wt. % | (wt. % | (wt. % | (wt. % |
| | for a | for a | for a | for a | for a | for a | for a | for a | for a | for a |
| | total | total | total | total | total | total | total | total | total | total |
| | weight | weight | weight | weight | weight | weight | weight | weight | weight | weight |
| | of the | of the | of the | of the | of the | of the | of the | of the | of the | of the |
| Component | sample) | sample) | sample) | sample) | sample) | sample) | sample) | sample) | sample) | sample) |
| Polyol | 43.12 | 53.58 | 44.11 | 44.11 | 55.94 | 50.49 | 57.34 | 52.19 | 57.39 | 52.27 |
| component 1 | | | | | | | | | | |
| Polyol | 14.19 | 13.03 | 12.91 | 12.91 | 13.60 | 16.66 | 10.3 | 14.03 | 11.42 | 12.71 |
| component 2 | | | | | | | | | | |
| Chain | 3.47 | 2.36 | 1.94 | 1.94 | 1.58 | 2.22 | 2.52 | 2.30 | 2.07 | 2.30 |
| Extender 1 | | | | | | | | | | |
| Chain | 0.00 | 0.00 | 0.43 | 0.43 | 0.00 | 0.00 | 0.00 | 0.00 | 0.00 | 0.00 |
| Extender 2 | | | | | | | | | | |
| Surfactant | 3.86 | 2.62 | 2.15 | 2.15 | 2.73 | 2.47 | 2.79 | 2.55 | 2.30 | 2.56 |
| Catalyst | 1.00 | 1.00 | 0.75 | 0.75 | 0.28 | 0.12 | 0.22 | 0.26 | 0.12 | 0.25 |
| Isocyanate | 34.75 | 28.16 | 27.43 | 27.43 | 25.71 | 27.77 | 26.46 | 28.44 | 26.40 | 29.64 |
| Filler | 0.00 | 0.00 | 8.39 | 8.39 | 0.00 | 0.00 | 0.00 | 0.00 | 0.00 | 0.00 |

The sample polyurethane foam was formed by mixing all the liquid components (including the first polyol component, second polyol component, third polyol component, fourth polyol component, chain extender, surfactant, catalyst) until the liquid phase is homogeneous. Then, any fillers were added to the liquid mixture. The combined mixture was then mixed until it reached a homogeneous composition. Finally, the isocyanate was added to the combined mixture. The final mixture was cured in an over at 170° C. oven for several minutes.

The sample polyurethane foams were tested to determine performance based on variables as defined herein. Results for the tests are summarized in Table 2 below.

TABLE 2
Performance Parameters

| Property | S1 | S2 | S3 | S4 | S5 | S6 | CS1 | CS2 | CS3 | CS4 |
|---|---|---|---|---|---|---|---|---|---|---|
| Density (kg/m³) | 130 | 178 | 158 | 418 | 200 | 170 | 395 | 169 | 180 | 148 |
| CFD₇₀ (kPa) | 152.4 | 951.9 | 556.3 | 9075.5 | 1639.7 | 946.4 | 5773.8 | 498.1 | 560.2 | 427.8 |
| CFD70/D)\hat{ }2.6 | 0.49 | 1.34 | 1.07 | 1.39 | 1.71 | 1.53 | 1.02 | 0.80 | 0.77 | 0.97 |
| TG1 (° C.) | −17.37 | 9.49 | 8.79 | 9.23 | −1.53 | −18.78 | 14.13 | 9.42 | 44.37 | 87.65 |
| TG2(° C.) | 93.46 | 80.65 | 86.07 | 87.34 | 76.78 | 79.27 | 66.11 | 61.31 | N/A | N/A |
| TG3(° C.) | N/A | N/A | 128.23 | 129.23 | 128 | 133.07 | 127.84 | N/A | 127.26 | N/A |
| CFD/FTC@50% | 0.821 | 0.777 | 0.660 | 0.630 | 0.7724 | 0.746 | 0.845 | 0.790 | 0.776 | 0.700 |
| CFD@50% | 48.1 | 429.36 | 232.26 | 2345.92 | 415.6 | 300.8 | 1157.1 | 177.93 | 217.08 | 169.66 |
| FTC@50% | 58.58 | 552.43 | 351.91 | 3723.68 | 538.06 | 403.19 | 1368.7 | 225.19 | 279.9 | 242.29 |
| C-set (70 C., | 33% | 18% | 12% | 12.5% | 16.58% | 33.0% | 50.0% | 49.0% | 29.0% | 15.0% |
| 50%, 7 Days) | | | | | | | | | | |

Note that not all of the activities described above in the general description, or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A polyurethane foam comprising:
a first polyol component comprising a polyether polyol component,
a second polyol component comprising a polycaprolactone polyol component, and
an isocyanate component,
wherein the polyurethane foam comprises at least two distinct glass transition (Tg) peaks.

2. The polyurethane foam of claim 1, wherein the polyurethane foam comprises a first glass transition peak Tg1 located at a temperature of not greater than about 50° C.

3. The polyurethane foam of claim 1, wherein the polyurethane foam comprises a second glass transition peak Tg2 located at a temperature of at least about 50° C. and not greater than about 100° C.

4. The polyurethane foam of claim 1, wherein the polyurethane foam comprises a density of at least about 50 kg/m³ and not greater than about 500 kg/m³.

5. The polyurethane foam of claim 1, wherein the polyurethane foam comprises a ratio PF_{CFD}/PF_{D}\hat{ }2.6 of at least about 0.3, where PF_{CFD} is equal to the compression force deflection (CFD) of the polyurethane foam and PF_{D} is equal to the density of the polyurethane foam.

6. The polyurethane foam of claim 1, wherein the polyurethane foam comprises a ratio PF_{CFD}/P_{FFTC50} of at least about 0.5, where PF_{CFD} is equal to the compression force deflection (CFD) of the polyurethane foam and PF_{FTC50} is equal to the force to compress (FTC) of the polyurethane foam.

7. The polyurethane foam of claim 1, wherein the polyurethane foam comprises C-set (compression strain at 50%, 70° C. for 168 hours) of not greater than about 40%.

8. The polyurethane foam of claim 1, wherein the polyurethane foam comprises a first polyol component content of at least about 30 wt. % and not greater than about 60 wt. % for a total weight of the polyurethane foam.

9. The polyurethane foam of claim 1, wherein the polyurethane foam comprises a second polyol component content of at least about 3 wt. % and not greater than about 25 wt. % for a total weight of the polyurethane foam.

10. The polyurethane foam of claim 1, wherein the polyurethane foam comprises an isocyanate component content of at least about 22 wt. % and not greater than about 50 wt. % for a total weight of the polyurethane foam.

11. The polyurethane foam of claim 1, wherein the polyurethane foam further comprises a first chain extender component.

12. The polyurethane foam of claim 11, wherein the polyurethane foam comprises a first chain extender component content of at least about 0.5 wt. % for a total weight of the polyurethane foam.

13. The polyurethane foam of claim 11, wherein the polyurethane foam comprises a first chain extender component content of not greater thana bout 6.0 wt. % for a total weight of the polyurethane foam.

14. A polyurethane foam comprising a reaction product of a raw mixture, wherein the raw material mixture comprises:
a raw first polyol component comprising a polyether polyol component,
a raw second polyol component comprising a polycaprolactone polyol component, and
a raw isocyanate component,
wherein the polyurethane foam comprises at least two distinct glass transition (Tg) peaks.

15. The polyurethane foam of claim 14, wherein the polyurethane foam comprises a first glass transition peak Tg1 located at a temperature of not greater than about 50° C.

16. The polyurethane foam of claim 14, wherein the polyurethane foam comprises a second glass transition peak Tg2 located at a temperature of at least about 50° C. and not greater than about 100° C.

17. The polyurethane foam of claim 14, wherein the polyurethane foam comprises a density of at least about 50 kg/m³ and not greater than about 500 kg/m³.

18. The polyurethane foam of claim 14, wherein the polyurethane foam comprises a ratio PF_{CFD}/PF_{D}\hat{ }2.6 of at least about 0.3, where PF_{CFD} is equal to the compression force deflection (CFD) of the polyurethane foam and PF_{D} is equal to the density of the polyurethane foam.

19. The polyurethane foam of claim 14, wherein the polyurethane foam comprises a ratio PF_{CFD}/P_{FFTC50} of at least about 0.5, where PF_{CFD} is equal to the compression force deflection (CFD) of the polyurethane foam and PF_{FTC50} is equal to the force to compress (FTC) of the polyurethane foam.

20. A method of forming a polyurethane foam comprising:
providing a raw material mixture comprising:
a raw first polyol component comprising a polyether polyol component,
a raw second polyol component comprising a polycaprolactone polyol component, and
a raw isocyanate component, and
forming the raw material mixture into a polyurethane foam,
wherein the polyurethane foam comprises at least two distinct glass transition (Tg) peaks.
